(19) United States
(12) Patent Application Publication
(10) Pub. No.: US 2023/0394559 A1
(43) Pub. Date: Dec. 7, 2023

(54) ORDER INFORMATION FOR ELECTRONIC DEVICES

(71) Applicant: Apple Inc., Cupertino, CA (US)

(72) Inventors: Nicholas J. SHEARER, London (GB); Felix-Johannes A. VISÉE, London (GB)

(21) Appl. No.: 17/956,767

(22) Filed: Sep. 29, 2022

Related U.S. Application Data
(60) Provisional application No. 63/349,131, filed on Jun. 5, 2022.

(51) Int. Cl. G06Q 30/06; G06Q 20/20; G06Q 20/32; G06Q 20/36; G06Q 20/40; G06Q 20/38

(52) U.S. Cl. CPC G06Q 30/0635; G06Q 20/20; G06Q 20/3278; G06Q 20/36; G06Q 20/4014; G06Q 20/3825; G06Q 20/3829; G06Q 2220/00

(57) ABSTRACT

Aspects of the subject technology provide for obtaining, displaying, and/or updating order information for electronic devices. An electronic device may receive a link to an order corresponding to a transaction. The transaction may have been performed using the electronic device or another device. The link may include or be provided with an order identifier and authentication information. The electronic device may request order information for the order using the order identifier and the authentication information, and receive the order information responsive to providing the order identifier and the authentication information to a merchant system server using the link. The order information may be stored for display in a wallet application at the electronic device.

### CROSS REFERENCE TO RELATED APPLICATIONS

This application claims the benefit of priority to U.S. Provisional Patent Application No. 63/349,131, filed on Jun. 5, 2022, the disclosure of which is hereby incorporated herein in its entirety.

### TECHNICAL FIELD

The present description relates generally to electronic devices, including, for example, order information for electronic devices.

### BACKGROUND

Electronic devices, such as phones, smart watches, etc., may be used to conduct electronic transactions with wireless transaction terminals. For example, one or more applets that correspond to one or more credentials (e.g., card accounts, transit accounts, etc.) may be provisioned on a secure element of an electronic device, and may be used to conduct wireless transactions with one or more wireless transaction terminals.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which order information for electronic devices may be implemented in accordance with one or more implementations.

FIG. 2 illustrates an example electronic device that may implement order information for electronic devices in accordance with one or more implementations.

FIG. 3 illustrates an example electronic device displaying a user interface of wallet application for viewing orders in accordance with one or more implementations.

FIG. 4 illustrates a schematic diagram of a transaction performed using an electronic device in accordance with one or more implementations.

FIG. 5 illustrates a schematic diagram of an electronic device obtaining order information associated with a transaction in accordance with one or more implementations.

FIG. 6 illustrates a schematic diagram of an electronic device of a user sharing order information with another electronic device of another user in accordance with one or more implementations.

FIG. 7 illustrates a schematic diagram of an electronic device of a user synchronizing order information with other device of the user in accordance with one or more implementations.

FIG. 8 illustrates a flow diagram of an example process for providing order information in accordance with one or more implementations.

FIG. 9 illustrates a flow diagram of another example process for providing order information in accordance with one or more implementations.

FIG. 10 illustrates a flow diagram of another example process for providing order information in accordance with one or more implementations.

FIG. 11 conceptually illustrates an electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Electronic devices may be used to perform electronic transactions. For example, electronic device may store payment information that can be used to execute payments at a physical point of sale device or with a merchant server over a network connection. For example, in mobile transaction (e.g., payment) systems, applets that correspond to a user's credentials, including payment card accounts, may be provisioned on a secure element of the user's electronic device(s). In some use cases, the applets on the secure element may be used to conduct transactions with wireless transaction terminals (e.g., in lieu of using the physical cards that correspond to the card accounts). For example, a wireless transaction terminal may receive a credential from a user device (e.g., via near-field communication (NFC)), and may pass the credential to a merchant acquirer bank. The merchant acquirer bank may pass the credential to the transaction network (e.g., payment network), associated with the credential, and the transaction network may communicate with the bank that issued the credential to conduct the transaction. In other use cases, a merchant server may receive a credential from a user device, (e.g., via a wired or wireless network such as the Internet) and may pass the credential to a merchant acquirer bank. The merchant acquirer bank may pass the credential to the transaction network (e.g., payment network), associated with the credential, and the transaction network may communicate with the bank that issued the credential to conduct the transaction.

Electronic transactions, such as payments, are often associated with an order, such as an order for a product or a service from a merchant. However, to find information about an order after a transaction, a user typically must navigate to an email application or messaging application to obtain a receipt for the order, or separately navigate to a merchant web page to view information about the order.

Aspects of the subject technology provide for order information, for an order, to be obtained by an electronic device (e.g., an electronic device that is associated with a transaction for the order) for display in, for example, a wallet application at the electronic device.

In accordance with one or more implementations, a link to order information may be provided to an electronic device such as a smart phone, a smart watch or other wearable electronic device, a tablet device, or other mobile device, a laptop computer, a desktop computer or the like. The order information may be associated with an order corresponding to a transaction, and the link may be provided to the electronic device during the transaction or after completion of the transaction. In one or more implementations, the wallet application at the electronic device may obtain, using the link and other information provided with the link, the order information for the order. The order information may be stored, for example, for display by the wallet application at the electronic device. In various implementations, the order information can be automatically updated at the electronic device, synchronized across multiple devices of a user, and/or sent to another device of another user.

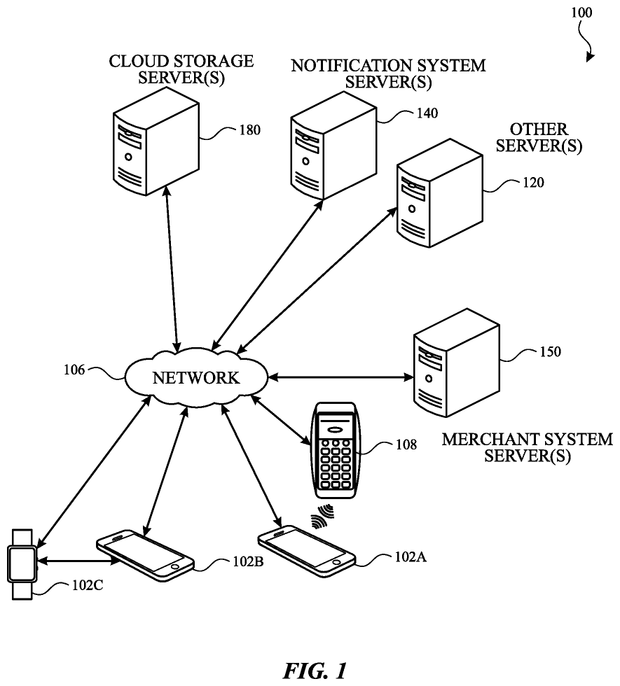

FIG. 1 illustrates an example network environment 100 by which order information may be provided, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes one or more electronic devices 102A-C, a network 106, one or more wireless transaction terminals 108, one or more merchant system servers 150, one or more notification system servers 140, one or more cloud storage servers 180, and/or one or more other servers 120 (e.g., one or more mobile transaction system servers, one or more transaction network servers, one or more card account provider servers, one or more issuing bank servers, and/or one or more receiving bank servers). The network 106 may communicatively couple, for example, one or more of the electronic devices 102A-C and/or the one or more wireless transaction terminals 108 to one or more of the servers 120, 140, 150, and/or 180 and may communicatively couple any two or more of the servers 120, 140, 150, and/or 180.

In one or more implementations, the network 106 may be an interconnected network of devices that may include, or may be communicatively coupled to, the Internet. For explanatory purposes, a physical wireless transaction terminal 108 is described herein as conducting wireless transactions with one or more of the electronic devices 102A-C. However, the one or more merchant system servers 150, and/or the one or more other servers 120 may also facilitate electronic transactions that occur over the network 106 which may not utilize a physical wireless transaction terminal 108, such as transactions performed with the merchant system server(s) 150. In various implementations, the merchant system server(s) 150 may be server(s) owned and/or operated by or on behalf of a merchant that provides products and/or services, and/or may be or include one or more marketplace servers that handle transactions on behalf of a merchant.

The one or more other servers 120 may include one or more servers that facilitate providing a mobile transaction system to the electronic devices 102A-C. The one or more other servers 120 may include one or more secure mobile platform (SMP) trusted services manager (TSM) servers, one or more broker servers, one or more application servers, and/or generally any server(s) that may facilitate providing a mobile transaction system. In one or more implementations, an authorized user of the electronic devices 102B and 102C may have a user account with the mobile transaction system provided by the one or more other servers 120 and an authorized user of the electronic device 102A may have a separate user account with a mobile transaction system. The user accounts may be used to manage the various card accounts and/or credentials that the users have registered with the mobile transaction system (e.g., via the one or more other servers 120).

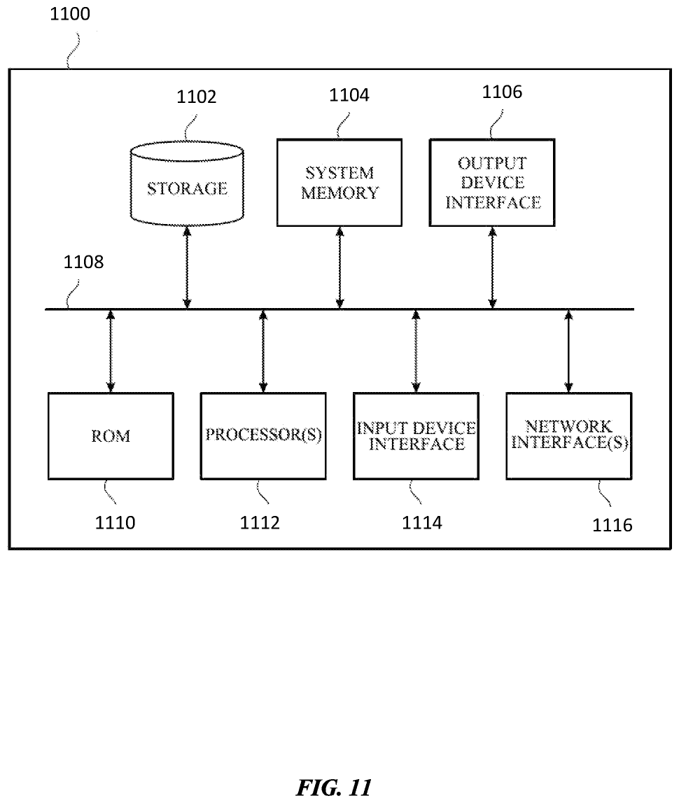

The one or more other servers 120 may be, and/or may include all or part of, the electronic system discussed below with respect to FIG. 11. For explanatory purposes, the one or more other servers 120 are described herein with reference to a single other server 120 in some examples. However, the one or more other servers 120 may include multiple servers that may correspond to multiple different systems.

The other servers 120 may also include one or more servers that may provide a transaction network, such as a payment network. One or more of the other servers 120 may include one or more broker servers, one or more application servers, and/or generally any server(s) that may facilitate providing a transaction network. In one or more implementations, the other servers 120 may include multiple servers that each correspond to a different payment network

One or more of the electronic devices 102A-C may be, for example, a portable computing device such as a laptop computer, a smartphone, a tablet device, a wearable device (e.g., watch, band, etc.), or other appropriate devices that include one or more wireless interfaces, such as one or more NFC radios, WLAN radios, Bluetooth radios, Zigbee radios, cellular radios, and/or other wireless radios. In FIG. 1, by way of example, the electronic devices 102A-B are depicted as smartphones and the electronic device 102C is depicted as a smartwatch. In FIG. 1, the electronic devices 102B and 102C are illustrated as being paired to one another and are associated with the same user account, while the electronic device 102A is associated with a different user account. In one or more implementations, the user accounts may be provided by, and/or accessible to, the one or more other servers 120 and/or one or more cloud storage servers 180.

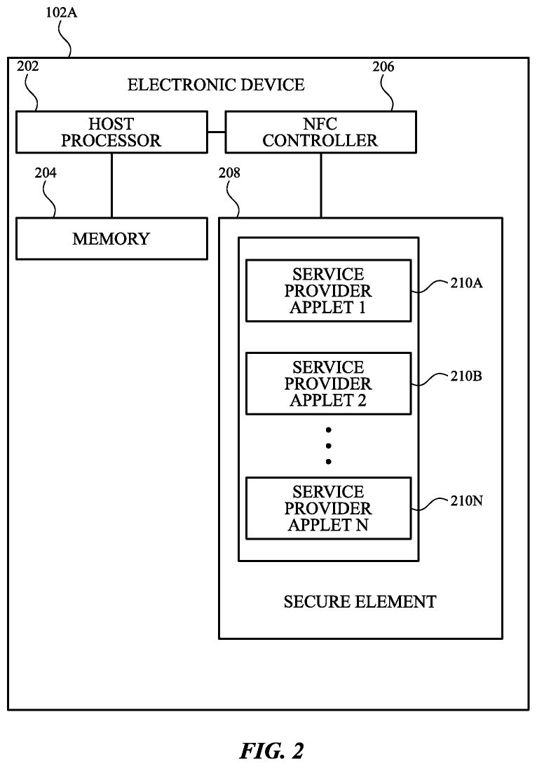

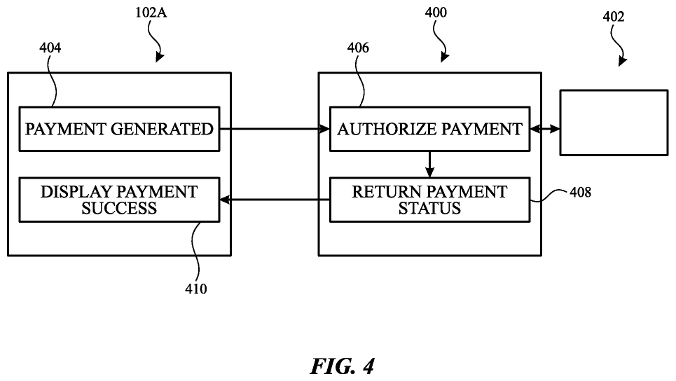

In one or more implementations, the electronic devices 102A-C may each include a secure element onto which one or more applets corresponding to, for example, credit/debit card accounts of the associated users, including physical card accounts, may be provisioned. An example electronic device that includes a secure element is discussed further below with respect to FIG. 2. One or more of the electronic devices 102A-C may be, and/or may include all or part of, the electronic system discussed below with respect to FIG. 11. Example processes of any of the electronic devices 102A-C in the subject system are discussed further below with respect to FIGS. 4-10.

The one or more wireless transaction terminals 108 may be, for example, wireless point of sale transaction terminals, wireless transit transaction terminals, wireless toll transaction terminals, wireless parking meter transaction terminals, and/or any devices that include one or more wireless interfaces that may be used to perform a wireless transaction, such as NFC radios, wireless local area network (WLAN) radios, Bluetooth radios, Zigbee radios, cellular radios, and/or other wireless radios. In FIG. 1, by way of example, the wireless transaction terminal 108 is depicted as a wireless point of sale transaction terminal. The wireless transaction terminal 108 may be, and/or may include all or part of, the electronic system discussed below with respect to FIG. 11, and/or the electronic device discussed below with respect to FIG. 2.

In one or more implementations of the subject system, a user of an electronic device, such as the electronic device 102A, may initiate a request to add a transaction credential (e.g., corresponding to a physical card account with one of the card account providers), for use in a mobile transaction system. For example, the request may be provided by the electronic device 102A to the one or more other servers 120, such as mobile transaction system server. In response to the request, the one or more other servers 120 (e.g., in conjunction with a corresponding one or more card account provider server(s)) may provision an applet for the credential on a secure element of the electronic device 102A, which may be used to conduct transactions in the mobile transaction system, such as with the wireless transaction terminal 108 and/or with the merchant system server(s) 150. The one or more mobile transaction system server may also provide a representation (e.g., an image) of the transaction credential that may be displayed in a wallet application or other mobile transaction application on the electronic device 102A to facilitate conducting the transactions.

When the electronic device 102A conducts a transaction using a transaction credential, such as with the wireless transaction terminal 108 and/or the merchant system server(s) 150, wireless transaction terminal 108 and/or the merchant system server(s) 150 may pass the transaction credentials provided by the applet to the one of the other servers 120 (e.g., a transaction network server corresponding to the transaction network associated with the applet). In one or more implementations, the wireless transaction terminal 108 may pass the transaction credential to a server associated with a receiving bank server (e.g., a merchant acquirer bank), the receiving bank server may communicate with the transaction network server to facilitate completing the transaction with an issuing bank server associated with the transaction credential. An example transaction flow is discussed further below with respect to FIG. 4.

In one or more implementations, once a transaction has been successfully completed by, for example, the electronic device 102A for an order with, for example, the merchant system server(s) 150, order information may be provided (e.g., from the merchant system server(s) 150)) to the electronic device 102A as discussed in further detail herein after in connection with, for example, FIGS. 4-10.

FIG. 2 illustrates an example electronic device 102A that may implement order information in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, one or more components of the electronic device 102A may be implemented by one or more of the electronic devices 102B-C.

As shown in FIG. 2, the electronic device 102A may include a host processor 202, a memory 204, an NFC controller 206, and a secure element 208. The secure element 208 may include one or more interfaces for communicatively coupling (directly or indirectly) to the NFC controller 206 and/or the host processor 202, such as via one or more single wire protocol (SWP) connections and/or any other data connection. The secure element 208 may include one or more provisioned service provider applets 210A-N, which may be referred to herein as applets 210A-N that may correspond to different service providers, such as credit card providers, debit card providers, transit providers, food/beverage providers, and the like. In one or more implementations, the operating system and/or execution environment of the secure element 208 may be a JAVA-based operating system and/or JAVA-based execution environment, and the applets 210A-N may be JAVA-based applets. In other implementations, other operating systems, languages, and/or environments can be implemented. In addition to the one or more applets 210A-N, the secure element 208 may also include one or more additional applets for performing other operations, such as a security applet, a registry applet, and the like.

The applets 210A-N may be provisioned on the secure element 208 in part by, for example, a trusted services manager server and/or a broker server, such as a mobile transaction system server and/or a card account provider server of the other servers 120. For example, the trusted services manager server and/or the broker server may transmit a provisioning script to the electronic device 102A via the network 106. In some implementations, the host processor 202 of the electronic device 102A may receive the script and may provide the script to the secure element 208, such as via the NFC controller 206 and/or directly to the secure element 208. The secure element 208 may perform one or more security mechanisms to verify the received script, such as one or more security mechanisms inherent in the GlobalPlatform framework, and may then execute the received script. The execution of the script by the secure element 208 may cause one or more of the applets 210A-N to be provisioned on the secure element 208.

Each of the applets 210A-N may be provisioned with one or more of: an applet identifier, a transaction network identifier, a device primary account number (DPAN), an identifier of the associated service provider, a priority attribute, one or more applet group attributes, and/or one or more other attributes. The applet identifier associated with a given applet 210A may be used by, for example, the host processor 202 and/or the trusted services manager server to uniquely identify the applet 210A relative to the other applets 210A-N provisioned on the secure element 208, such as to perform one or more operations with respect to the applet 210A. In one or more implementations, the applet identifiers may be used by the host processor 202 to store associations between the applets 210A-N and the corresponding service providers.

The DPAN may be associated with a card account, such as a credit card account, that is associated with a given applet 210A. In contrast to the DPAN, the actual number that is printed on the physical card may be referred to as a funding primary account number (FPAN). When conducting a wireless transaction (e.g., a payment) using one of the applets 210A-N, the secure element 208 may provide the DPAN to a wireless transaction terminal 108 and/or the merchant system server(s) 150 (e.g., without providing the FPAN which may not be stored on the secure element 208). The wireless transaction terminal 108 may then forward the DPAN to the associated service provider who can determine the account (e.g., the FPAN) associated with the DPAN, and confirm that the account contains sufficient funds and/or credit to complete the wireless payment transaction. In one or more implementations, the DPAN may be associated with a card account that is associated with a given applet 210A, but there may not be a physical card corresponding to the DPAN.

In one or more implementations, the applets 210A-N may also be provisioned with an attribute that indicates the type of communication protocol used by the applets 210A-N to communicate with a wireless transaction terminal. The types of communication protocols may include, for example, an NFC-A protocol (or Type A), an NFC-B protocol (or Type B), an NFC-F protocol (or Type F or FeliCA), a Bluetooth protocol, a Bluetooth low energy (BLE) protocol, a Zigbee protocol, a Wi-Fi protocol, or generally any communication protocol. In one or more implementations, one or more of the communication protocols may be supported by a second secure element (not shown) that is logically presented to the electronic device 102A (e.g., with the secure element 208) as a single secure element.

The NFC controller 206 may include one or more antennas and one or more transceivers for transmitting/receiving NFC communications. The NFC controller 206 may further include one or more interfaces, such as a single wire protocol interface, for coupling to the host processor 202 and/or the secure element 208. The NFC controller 206 may be able to communicate via one or more different NFC communication protocols, such as NFC-A (or Type A), NFC-B (or Type B), NFC-F (or Type F or FeliCA), and/or International Organization for Standardization (ISO)/International Electrotechnical Commission (IEC) 15693. The NFC-A protocol may be based on ISO/IEC 14443A and, e.g., may use Miller bit coding with a 100 percent amplitude modulation. The NFC-B protocol may be based on ISO/IEC 14443B and, e.g., may use variations of Manchester encoding along with a 10 percent modulation. The NFC-F protocol may be based on FeliCA JIS X6319-4 and, e.g., may use a slightly different variation of Manchester coding than the NFC-B protocol.

For explanatory purposes, the electronic device 102A is illustrated in FIG. 2 as utilizing the NFC controller 206 to communicate with a wireless transaction terminal. However, the electronic device 102A may use any wireless communication controller and/or protocol to communicate with a wireless transaction terminal, such as Bluetooth, Bluetooth low energy, Wi-Fi, Zigbee, millimeter wave (mmWave), or generally any wireless communication controller and/or protocol, and/or may use other wireless communication controllers and/or protocols (e.g., WiFi communications, etc.), to communicate with other points of sale such as merchant system server(s) 150.

The host processor 202 may include suitable logic, circuitry, and/or code that enable processing data and/or controlling operations of the electronic device 102A. In this regard, the host processor 202 may be enabled to provide control signals to various other components of the electronic device 102A. The host processor 202 may also control transfers of data between various portions of the electronic device 102A. Additionally, the host processor 202 may enable implementation of an operating system or otherwise execute code to manage operations of the electronic device 102A. The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, one or more of the host processor 202, the memory 204, the NFC controller 206, the secure element 208, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

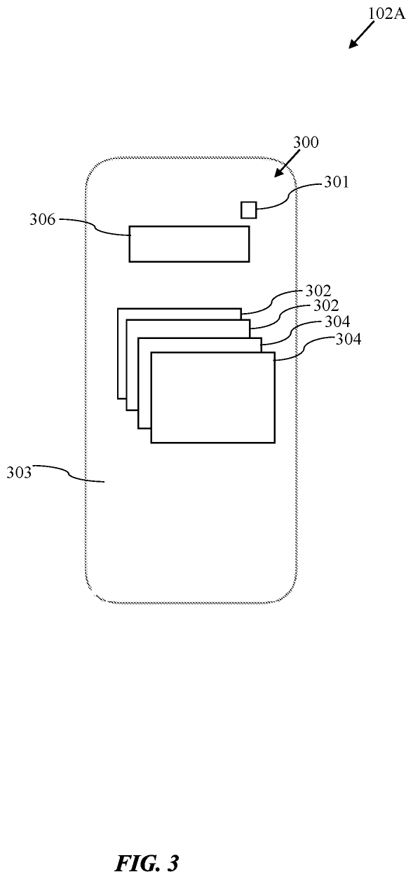

FIG. 3 illustrates an example in which the electronic device 102A is displaying a user interface 300 of a wallet application on a display 303 of the electronic device. In this example, the user interface 300 includes representations 302 (e.g., images) of the transaction credentials corresponding to the applets of FIG. 2. For example, the representations 302 may be images of payment cards for which applets 210A-210N are stored by the secure element 208.

In the example of FIG. 3, the user interface 300 also includes representations 304 of one or more passes (e.g., tickets such concert tickets, or access passes such as public transport access passes) that may also be displayed in the user interface 300 and/or securely managed by the secure element 208. Passes represented by representations 304 may be loaded into the wallet application by, for example, a user logging into an account of a pass provider (e.g., an airline or a ticket vendor), downloading a copy of the pass from the pass provider, and instructing the electronic device to store the pass in the wallet application.

In the example of FIG. 3, the user interface 300 also includes a user interface element 301 for accessing order information associated with one or more orders (e.g., orders corresponding to transactions performed using one of the applets of FIG. 2, and/or other orders associated with a user of the electronic device 102A). For example, selecting the user interface element 301 may cause the user interface 300 to display order information for one or more orders for which order information has been obtained by the wallet application for orders for which the payment cards represented by the representations 302 were used for payment. For example, for orders paid for using the payment cards represented by the representations 302, a link to order information for the order may be provided to the wallet application in the background (e.g., without user interaction to obtain the link). The wallet application may then obtain (e.g., using the link and other information provided with the link), order information for the order, for display within the user interface 300. In other examples, the user interface 300 may display order information obtained by the wallet application for other orders (e.g., orders not paid for with the payment cards represented by the representations 302), such as e-commerce orders or other orders. For example, for orders not paid for with the payment cards represented by the representations 302, the order information accessed by the user interface element 301 may be received at the electronic device 102A via a link received in an email or a text message from merchant with which the order was completed. For example, a user of the electronic device 102A may select the link received via email or message, the link causing the wallet application to obtain (e.g., using the link and other information received with the link) the order information.

In the example of FIG. 3, the user interface 300 also includes a notification 306 indicating an update to an order information associated with one or more orders (e.g., one or more orders for which additional order information can be obtained via the user interface element 301). In one or more implementations, notifications such as the notification 306 may be generated (e.g., within the wallet application and/or outside the wallet application at the electronic device 102A) responsive to receiving a push notification of an update to an order for which order information is stored at the electronic device 102A (e.g., and for which the electronic device 102A has registered for updates). In one or more implementations, order information stored at the electronic device 102A may be stored in connection with information regarding one or more transactions performed using the payment cards represented by the representations 304, and the order information may be accessible from within a list of transactions at the electronic device. For example, the electronic device 102A may receive transaction information (e.g., payment status information) for a transaction (e.g., a payment), receive order information for an order, determine (e.g., on device) that the order information corresponds to a transaction in the transaction information, and display some or all of the order information in connection with the transaction in the list of transactions.

FIG. 4 schematically illustrates a transaction that can be performed by the electronic device 102A. In the example of FIG. 4, a payment is generated (404) at the electronic device 102A with a point of service 400 (e.g., the wireless transaction terminal 108 and/or the merchant system server(s) 150). As shown, the point of service 400 may authorize (406) the payment (e.g., by interacting with a payment processing system 402, such as a transaction network servers, an issuing bank server, and/or a receiving bank server), and return (408) payment status information (e.g., payment success information) to the electronic device 102A. In the example of FIG. 4, the electronic device 102A displays (410) the payment status information, such as by displaying a notification that the payment was successful. In the example of FIG. 4, only payment status information is provided to the electronic device 102A. However, in many use cases, the payment process of FIG. 4 may be a payment process for an order for goods or services.

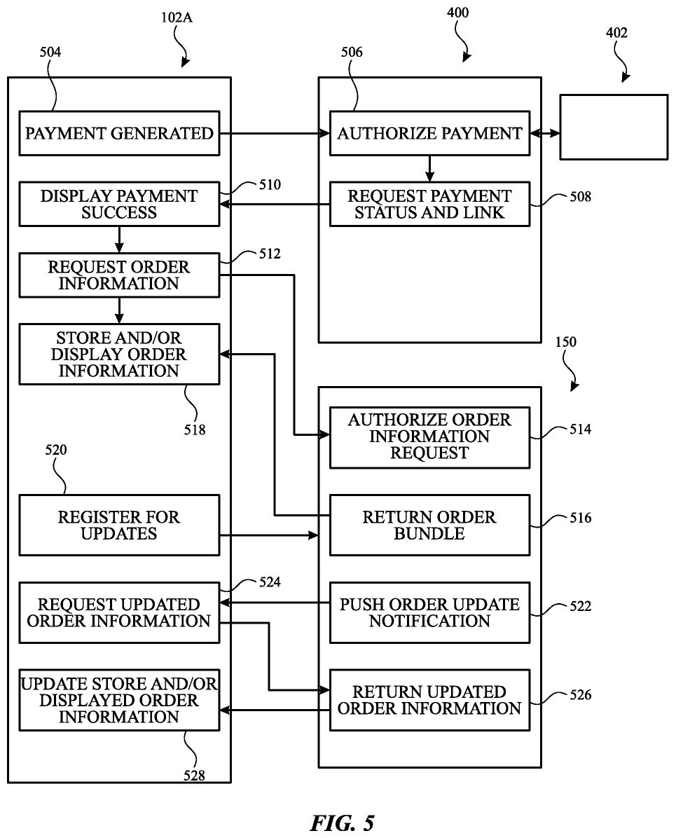

FIG. 5 schematically illustrates a process for providing order information to the electronic device 102A following a transaction. As shown in FIG. 5, a payment is generated (504) at the electronic device 102A with the point of service 400 (e.g., the wireless transaction terminal 108 and/or the merchant system server(s) 150). As shown, the point of service 400 may authorize (506) the payment (e.g., by interacting with a payment processing system 402, such as a transaction network server, an issuing bank server, and/or a receiving bank server), and return (508) payment status information (e.g., payment success information) and a network identifier such as a link to the electronic device 102A. In one or more implementations, other information, such as a merchant identifier, an order identifier, and/or authentication information, can also be provided with the link. In one or more implementations, the other information may help protect the privacy of a user that performs a transaction for an order, by preventing unauthorized access to the order information. For example, the other information may include authentication information (e.g., an authentication token) that prevents unauthorized devices from obtaining the order information. In the example of FIG. 5, the electronic device 102A displays (510) the payment status information.

In the example of FIG. 5, the link is received from the point of service 400 and at the time of the transaction (e.g., along with the payment status). In one or more other implementations, the link can be provided from an entity other than the point of service 400 (e.g., the link can be provided by the merchant system server(s) 150 after a transaction is performed by the wireless transaction terminal 108, or the link can be provided by the merchant system server(s) 150 after a transaction is performed by a marketplace server that handles sales on behalf of a merchant). Moreover, the link can be provided at the time of the transaction (e.g., together with the payment status information) or at a later time. Moreover, the link can be provided via the same communication protocol with which the payment status information is provided (e.g., in a background communication to a wallet application, together with the payment status information) or via a separate communication protocol (e.g., the payment status information may be provided as a background communication to the wallet application, and the link can be separately provided in an email or a text message). The link may be or include a network address at which order information, for an order associated with the transaction, can be obtained.

As shown in FIG. 5, after receiving the link and/or the other information, the electronic device 102A may request (512) order information from the merchant system server(s) 150. For example, the electronic device 102A may send some or all of the other information received with the link, to the merchant system server(s) 150 at a network address identified using the link. In one or more implementations, the merchant system server(s) 150 may authorize (514) the order information request. For example, authorizing the order information request may include determining that a merchant identifier in the request corresponds to the merchant identifier of the merchant associated with the merchant system server(s) 150, determining that an order identifier received in the request corresponds to an order with the merchant, and/or verifying that the electronic device 102A is authorized to receive the order information by determining that authentication information (e.g., an authentication token) received with the request corresponds to the authentication information (e.g. an authentication token) that was provided from the point of service 400 with the link.

As shown in FIG. 5, following authorization of the order information request, the merchant system server(s) 150 may return (516) the order information (e.g., in an order bundle) to the electronic device 102A. The order information provided in the order bundle may include one or more of an image associated with the order, a logo of a merchant associated with the system, a status of the order, a name of the merchant associated with the order, an order number, a name of a product or service associated with the order, shipping information for the order, an amount associated with the order, an additional link for modifying the order, pickup information, and/or an encoded identifier (e.g., a bar code or a quick response (QR) code) of the order.

In one or more implementations, the order information (e.g., the order bundle) may be cryptographically signed by the merchant system server(s) 150 (e.g., using a certificate obtained from a mobile transaction system server(s) of the other servers 120 and/or using a private key of the merchant system server(s)). For example, the merchant system server(s) 150 may have previously registered with, for example, mobile transaction system server to obtain a merchant identifier and a certificate for use in cryptographically signing order information. In this way, the electronic device 102A may be provided with the ability to verify the order information (e.g., using the certificate of the merchant system server(s) 150). In one or more implementations, the order information (e.g., the order bundle) may include a cryptographically signed manifest that allows the electronic device 102A to verify that the contents of the order information (e.g., including a price of the order) has not be modified or altered. In one or more implementations, the order information may be provided in an encrypted bundle, encrypted by the merchant system server(s) 150 using a private key of the merchant system server(s) 150 and a public key of the electronic device 102A (e.g., obtained from another system, such as the cloud storage server(s) 180 of FIG. 1).

As shown in FIG. 5, after receiving the order information (e.g., the order bundle), the electronic device 102A may store and/or display (518) (e.g., in the user interface 300 of a wallet application) the order information. In one or more implementations, the electronic device 102A may receive the order information as an encrypted and cryptographically signed bundle, verify the encrypted bundle using the cryptographic signature, and decrypt the encrypted bundle using a private key of the electronic device 102A and a public key of the merchant system server(s) 150 (e.g., obtained from another system, such as the cloud storage server(s) 180 of FIG. 1) prior to storing and/or displaying the order information.

As shown in FIG. 5, the electronic device 102A may also register (520) with the merchant system server(s) 150 for updates to order information. In one or more implementations, registering for the updates may include providing a push token from the electronic device 102A to the merchant system server(s) 150. At a time after the electronic device 102A is registered for the updates, the merchant system server(s) 150 may receive or generate an update to an order, and push (522) an order update notification to the electronic device 102A. As examples, an update to an order may include a status update indicating a processing status, a complete status, a read-for-shipment status, a shipped status, a tracking number, an out-for-delivery status, a delivered status, and/or an issue status indicating an issue or problem with the order. In the example of FIG. 5, the electronic device 102A receives the order update notification push message, and requests (524) updated order information responsive to receiving order update notification push message. As shown, responsive to the request for the updated order information, merchant system server(s) 150 return (526) updated order information to the electronic device 102A. The electronic device 102A may then update (528) the stored and/or displayed order information at the electronic device 102A. In one or more implementations, the order update notification may be pushed to the electronic device 102A via the notification system server(s) 140 of FIG. 1.

In the example of FIG. 5, the electronic device 102A requests the updated order information responsive to receiving a push order update notification. In this way, the electronic device 102A may be provided with the ability to obtain updates for several orders in response to a single update notification. However, in one or more other implementations, the updated order information may be pushed to the electronic device 102A with or as the push order update notification. In the example of FIG. 5, the link and the other information for obtaining order information are provided as part of a transaction executed, at least in part, by the electronic device 102A. However, it is appreciated that the link and the other information for obtaining order information can be received by a device other than a device that performed the transaction, and the order information and/or updates can be obtained, using the operations 512-528 of FIG. 5, by the device other than the device that performed the transaction.

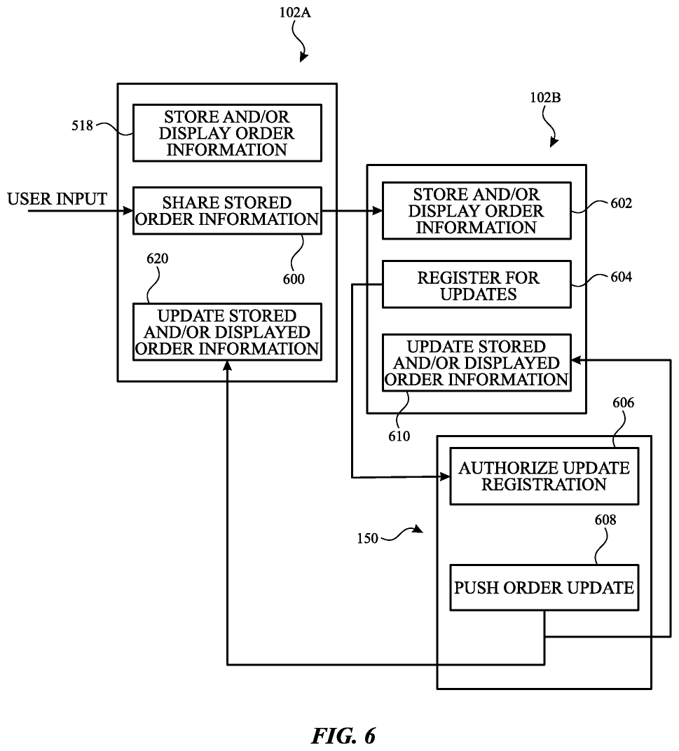

In one more implementations, an electronic device that has received order information, such as from a merchant systems server, may share that order information with one or more other electronic devices. The one or more other electronic devices may include other electronic devices that are associated with the same user account as a user account to which the electronic device is associated, and/or one or more other electronic devices associated with other user accounts. FIG. 6 illustrates an example in which the electronic device 102A shares order information with another electronic device (e.g., electronic device 102B) associated with a different user account from the user account with which the electronic device 102A is associated.

As shown in FIG. 6, the electronic device 102A may store and/or display (518) order information, as described herein in connection with FIG. 5. After storing and/or displaying the order information, the electronic device 102A may receive a user input requesting sharing of the stored order information. As example, the user input may be a user instruction to send the order information in a text message, to send the order information in an email, or to transmit the order information via a direct wireless communication (e.g., a Bluetooth communication). As shown, electronic device 102A may, in response to the user input, share (600) the stored order information with the electronic device 102B (e.g., by sending the order information in a text message, in an email, or via a direct wireless communication according to the user input).

Electronic device 102B may then store and/or display (602) the order information locally at the electronic device 102B (e.g., within a wallet application at the electronic device 102B). In the example of FIG. 6, electronic device 102A may already have registered (520) for updates to the order information, as described here in connection with FIG. 5. As shown in FIG. 6 the electronic device 102B may also register (604) for updates to the order information. As shown in FIG. 6, the merchant system server(s) 150 may authorize (606) the update registration requested by the electronic device 102B. In one or more implementations, authorizing the update registration request may include verifying that the registration request includes a merchant identifier associated with the merchant system server(s) 150, an order identifier associated with an order for the merchant system server(s) 150, authentication information (e.g., an authentication token) for receiving the order information. In one or more implementations, the request to register for the updates may also include a push token from the electronic device 102B that can be used to push notifications to the electronic device 102B.

As shown in FIG. 6, when an update is received or generated by the merchant system server(s) 150, the merchant system server(s) 150 may push (608) an order update to both the electronic device 102A and the electronic device 102B that have registered for the updates. Pushing the order update may include providing the order update information in a push notification, or may include providing an update notification that provokes a request for the update information (e.g., as in the example of FIG. 5) from the devices that receive the push notification. As shown, the electronic device 102A may then update (620) the stored and/or displayed order information at the electronic device 102A, and the electronic device 102B may update (610) the stored and/or displayed order information at the electronic device 102B. This can be useful in a scenario in which, for example, a user of the electronic device 102A places an order with a merchant corresponding to the merchant system server(s) 150, and the user of the electronic device 102A wishes to authorize a user of the electronic device 102B to pick up the order. Using the operations of FIG. 6, the electronic device 102A can provide order information (e.g., including pickup information, such as bar code or QR code, a pickup location, a pickup time, etc.) to the electronic device 102B, and the electronic device 102B can later receive any updates to the order information to aid the user of the electronic device 102B in picking up the order.

In the example of FIG. 6, the order information is shared between electronic devices associated with different user accounts, in response to a user input requesting the sharing. In one or more implementations, order information that has been received by an electronic device can also, or alternatively, be distributed to other electronic devices associated with the same user account, even without a user input requesting the sharing.

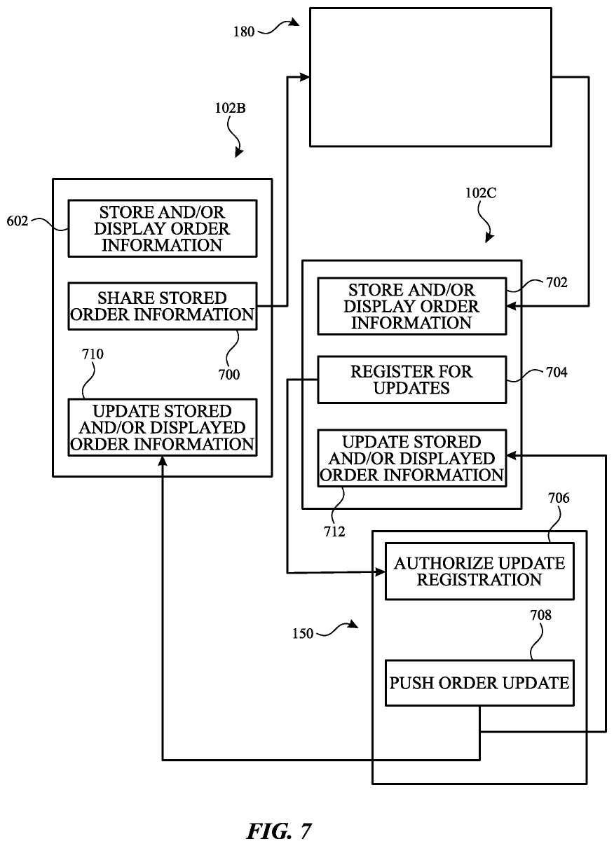

FIG. 7 illustrates an example in which the electronic device 102B shares order information with another electronic device (e.g., electronic device 102C) associated with the same user account as the user account with which the electronic device 102B is associated.

As shown in FIG. 7, the electronic device 102B may store and/or display (602) order information, as described herein in connection with FIG. 6. After storing and/or displaying the order information, the electronic device 102B may share (700) the stored order information with the electronic device 102C (e.g., via the cloud storage server(s) 180). For example, the electronic device 102B may provide the order information to the cloud storage server(s) 180 for storage in a shared storage for all electronic devices associated with the same user account as the electronic device 102B. The cloud storage server(s) 180 may then distribute the order information to the electronic device 102C and/or to any other electronic devices that are registered to the same accounts with the cloud storage server(s) 180.

In one or more implementations, electronic device 102C may then store and/or display (702) the order information locally at the electronic device 102C (e.g., within a wallet application at the electronic device 102C). In the example of FIG. 7, electronic device 102B may already have registered (604) for updates to the order information, as described here in connection with FIG. 6.

In one or more implementations, updates received at the electronic device 102B may also be distributed (e.g., sync'd) to the electronic device 102C via the cloud storage server(s) 180 in some use cases. As shown in FIG. 7, in one or more other use cases, the electronic device 102C may also register (704) for updates to the order information. As shown in FIG. 7, the merchant system server(s) 150 may authorize (706) the update registration requested by the electronic device 102C. In one or more implementations, authorizing the update registration request may include verifying that the registration request includes a merchant identifier associated with the merchant system server(s) 150, an order identifier associated with an order for the merchant system server(s) 150, and or authentication information (e.g., an authentication token) for receiving the order information. In one or more implementations, the request to register for the updates may also include a push token from the electronic device 102C that can be used to push notifications to the electronic device 102C.

As shown in FIG. 7, when an update is received or generated by the merchant system server(s) 150, the merchant system server(s) 150 may push (708) an order update to both the electronic device 102B and the electronic device 102C (e.g., and the electronic device 102A) that have registered for the updates. Pushing the order update may include providing the order update information in a push notification, or may include providing an update notification that provokes a request for the update information (e.g., as in the example of FIG. 5). As shown, the electronic device 102B may then update (710) the stored and/or displayed order information at the electronic device 102B, and the electronic device 102C may update (712) the stored and/or displayed order information at the electronic device 102C. This can be useful in a scenario in which, for example, a user of the electronic device 102B places an order with a merchant corresponding to the merchant system server(s) 150 or receives order information for the order from another electronic device such as the electronic device 102A, and the user of the electronic device 102B wishes to track and/or pick up the order using their other electronic device 102C. Using the operations of FIG. 7, order information (e.g., including pickup information, delivery information, and/or status information) can be synchronized to all of the electronic devices associated with the same user account.

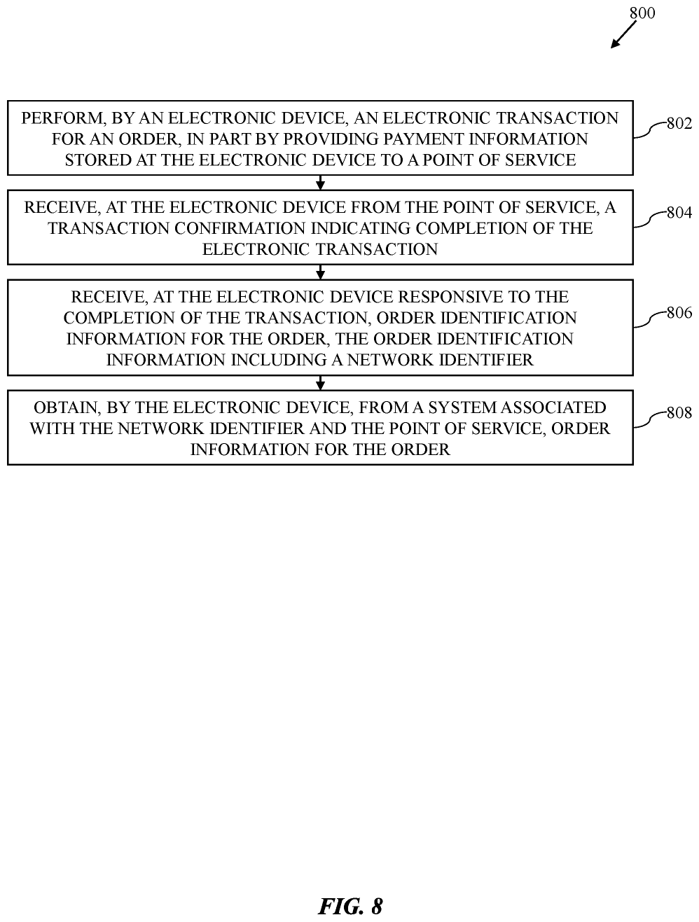

FIG. 8 illustrates a flow diagram of an example process 800 for providing order information for electronic devices in accordance with one or more implementations. For explanatory purposes, the process 800 is primarily described herein with reference to the electronic device 102A of FIG. 1. However, the process 800 is not limited to the electronic device 102A of FIG. 1, and one or more blocks (or operations) of the process 800 may be performed by one or more other electronic devices or systems, such the electronic device 102B or the electronic device 102C. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations. Further, one or more additional operations can be performed.

As shown in FIG. 8, at block 802, an electronic device (e.g., electronic device 102A) may perform an electronic transaction for an order, in part by providing payment information stored at the electronic device to a point of service (e.g., point of service 400, such as the wireless transaction terminal 108, the merchant system server(s) 150, and/or a marketplace server that handles sales on behalf of the merchant system server(s) 150). For example, the point of service may include a near field communications terminal (e.g., the wireless transaction terminal 108) associated with a merchant corresponding to the order. As another example, the point of service may include a merchant server (e.g., one of the merchant system server(s) 150) associated with a merchant corresponding to the order. In one or more implementations, the point of service executes the transaction by communicating with one or more transaction network servers, issuing bank server(s), and/or receiving bank server(s).

At block 804, the electronic device may receive, from the point of service, a transaction confirmation indicating completion of the electronic transaction. For example, the transaction confirmation may be a confirmation of a success of a payment.

At block 806, the electronic device may receive, responsive to the completion of the transaction, order identification information for the order, the order identification information including a network identifier (e.g., a link, such as a uniform resource locator (URL) or a uniform resource identifier (URI)). In one or more implementations, the order identification information includes a merchant identifier associated with a merchant corresponding to the order, an order identifier for the order, the network identifier, and authentication information (e.g., an authentication token).

At block 808, the electronic device may obtain, from a system (e.g., the merchant system server(s) 150) associated with the network identifier and the point of service, order information for the order. In one or more implementations, obtaining the order information for the order includes providing, by the electronic device, the merchant identifier, the order identifier, and the authentication information to the system at a network address corresponding to the network identifier. In one or more implementations, obtaining the order information for the order also includes receiving the order information from the system at the electronic device responsive to providing the merchant identifier, the order identifier, and the authentication information. In one or more implementations, the system may authorize (514) an order information request from the electronic device using the merchant identifier, the order identifier, and the authentication information.

In one or more implementations, obtaining the order information may include receiving the order information in an encrypted bundle with a cryptographic signature from the system associated with the network identifier. In one or more implementations, the process 800 may also include verifying the encrypted bundle using the cryptographic signature, and decrypting the encrypted bundle using a public key of the system obtained from another system. For example, the public key of the system may be obtained from the cloud storage server(s) 180. In one or more implementations, the encrypted bundle may have been encrypted by the system using a public key of the electronic device obtained by the system from the cloud storage server(s) 180 and using a private key of the system. In one or more implementations, the merchant attests, using the cryptographic signature, that the order information has not been tampered with or modified, and the electronic device can verify the attestation using a public key of the merchant (e.g., obtained from the cloud storage server(s) 180).

In one or more implementations, the electronic device stores the order information at the electronic device for display in a user interface (e.g., user interface 300) of a wallet application at the electronic device (e.g., as described herein in connection with FIG. 3). As illustrative examples, the order information may include one or more of an image associated with the order, a logo of a merchant associated with the system, a status of the order, a name of the merchant associated with the order, an order number, a name of a product or service associated with the order, shipping information for the order, an amount associated with the order, an additional link for modifying the order, pickup information, and an encoded identifier of the order. In one or more implementations, the order information may include status information for the order, such as an order received status, an order processing status, an order shipped status, an out-for-delivery status, a delivered status, and/or an issue/problem status.

In one or more implementations, the electronic device may receive, from a user of the electronic device after receiving the order information, a user input including a request to send the order information to another electronic device (e.g., electronic device 102B) associated with another user, and may send, responsive to the request, the order information to the other electronic device (e.g., as described herein in connection with FIG. 6).

In one or more implementations, the electronic device and at least one other electronic device (e.g., electronic device 102C) are associated with a user account, and the process 800 may also include synchronizing the order information across the electronic device and the at least one other electronic device by providing the order information to shared storage associated with the user account at a cloud storage server (e.g., cloud storage server(s) 180) for distribution from the cloud storage server to the at least one other electronic device (e.g., as described herein in connection with FIG. 7).

In one or more implementations, the electronic device may also register (520) for updates to the order information. For example, the electronic device may provide a push token to the system, and may receive push notifications regarding updates to the order information from the system using the push token.

In one or more implementations, the push token may be revoked by the user of the electronic device (e.g., by deleting the order information from the electronic device, such as from a wallet application at the electronic device). In one or more implementations, a push notification regarding updates to the order information may include the updates to the order, or the push notification may be a notification that updates are available and the electronic device may request the updates responsive to receiving the push notification. For example, the electronic device may, in response to receiving a push notification, ask the system which orders are updated, and request and receive updates for those orders that have updates (e.g., including one or multiple orders).

In the example of FIG. 8, order information is provided to an electronic device that was used to perform a transaction for the order. It is also appreciated that an electronic device may use the subject technology to obtain order information for orders for which a transaction was performed using a different device (e.g., a smartphone may obtain, store and/or display order information for an order that was placed using a laptop, or a smart watch may obtain, store and/or display order information for an order that was placed using a smartphone or a tablet device).

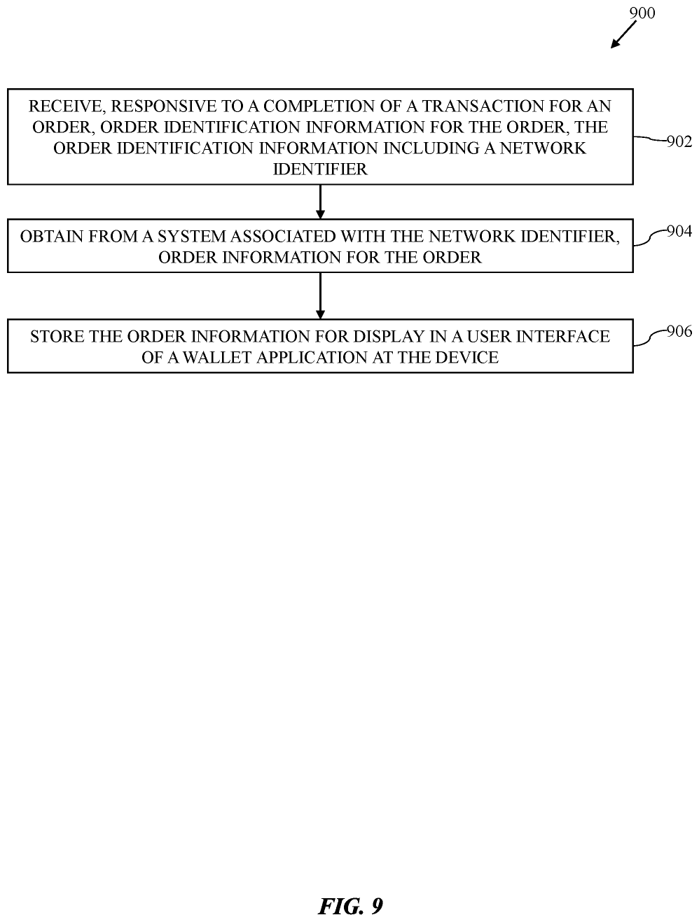

FIG. 9 illustrates a flow diagram of an example process 900 for providing order information in accordance with one or more implementations. For explanatory purposes, the process 900 is primarily described herein with reference to the electronic device 102A of FIG. 1. However, the process 900 is not limited to the electronic device 102A of FIG. 1, and one or more blocks (or operations) of the process 900 may be performed by one or more other electronic devices or systems, such the electronic device 102B or the electronic device 102C. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations. Further, one or more additional operations can be performed.

As shown in FIG. 9, at block 902, a device (e.g., electronic device 102A) may receive, responsive to a completion of a transaction for an order (e.g., a transaction performed by the electronic device 102A or a transaction performed by another electronic device), order identification information for the order, the order identification information including a network identifier (e.g., a link, such as a uniform resource locator (URL) or a uniform resource identifier (URI)). In one or more implementations, the order identification information includes a merchant identifier associated with a merchant corresponding to the order, an order identifier for the order, the network identifier, and authentication information (e.g., an authentication token).

At block 904, the device may obtain from a system (e.g., merchant system server(s) 150) associated with the network identifier, order information for the order. For example, the device may obtain the order information for the order by providing the merchant identifier, the order identifier, and the authentication information to the system at a network address corresponding to the network identifier, and receiving the order information from the system responsive to providing the merchant identifier, the order identifier, and the authentication information (e.g., following authorization (514) of the request by the system).

At block 906, the device may store the order information for display in a user interface (e.g., user interface 300) of a wallet application at the device. When a user of the device opens the wallet application and/or selects an orders section of the user interface of the wallet application, the order information from the order may be displayed in the user interface. In one or more implementations, the order information may also, or alternatively, be displayed in connection with a corresponding transaction in a list of transactions displayed in the user interface of the wallet application.

In one or more implementations, the device may also perform an electronic transaction for the order, in part by providing the payment information to a point of service. In one or more implementations, the device may also receive, from the point of service, a transaction confirmation indicating completion of the electronic transaction. In one or more implementations, the order identification information may be received along with the transaction confirmation. In one or more implementations, the point of service may include a near field communications terminal (e.g., wireless transactions terminal 108) associated with a merchant corresponding to the order or a merchant server (e.g., merchant systems server(s) 150) associated with a merchant corresponding to the order.

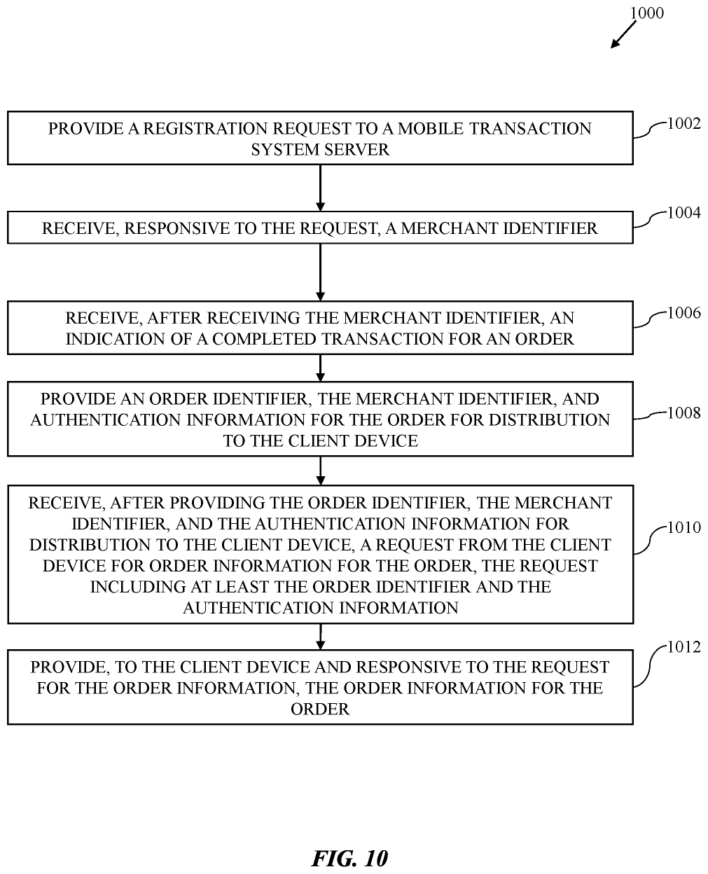

FIG. 10 illustrates a flow diagram of an example process 1000 that may be performed by a merchant server for providing order information for electronic transactions in accordance with one or more implementations. For explanatory purposes, the process 1000 is primarily described herein with reference to the merchant system server(s) 150 of FIG. 1. However, the process 1000 is not limited to the merchant system server(s) 150 of FIG. 1, and one or more blocks (or operations) of the process 1000 may be performed by one or more other electronic devices or systems. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations. Further, one or more additional operations can be performed.

As shown in FIG. 10, at block 1002, a merchant server (e.g., one or more of the merchant system server(s) 150) may provide a registration request to a mobile transaction system server (e.g., mobile transaction system server(s) of the other servers 120 of FIG. 1).

At block 1004, the merchant server may receive, responsive to the request (e.g., from the mobile transaction system server(s) of the other servers 120), a merchant identifier. In one or more implementations, the merchant server may also receive, responsive to the request, a certificate that can be used for signing order information and/or updates to order information.

At block 1006, the merchant server may receive, after receiving the merchant identifier, an indication of a completed transaction for an order (e.g., by a client device, such as electronic device 102A). For example, the merchant server may receive the indication of the completed transaction from a transaction network server and/or a mobile transaction system server of the other servers 120 of FIG. 1.

At block 1008, the merchant server may provide (e.g., responsive to receiving the indication of the completed transaction) an order identifier, the merchant identifier, and authentication information (e.g., an authentication token generated by the merchant server) for the order for distribution to the client device. For example, the merchant server may send the order identifier, the merchant identifier, and authentication information to the client device. The merchant server may provide the merchant identifier to the client device so that an order can be uniquely identified based on a combination of the merchant identifier and the order identifier.

At block 1010, the merchant server may receive, after providing the order identifier, the merchant identifier, and the authentication information for distribution to the client device, a request from the client device for order information for the order, the request including at least the order identifier and the authentication information.

At block 1012, the merchant server may provide, to the client device and responsive to the request for the order information, the order information for the order. In one or more implementations, the merchant server may authenticate the request using the authentication information received in the request, prior to providing the order information to the client device. For example, the merchant server may verify that the authentication information received in the request matches the authentication information that was distributed to the client device. In one or more implementations, the merchant server may also encrypt the order information before providing the order information to the client device. For example, the merchant server may encrypt the order information using public key information for the client device obtained from another system, such as from the cloud storage server(s) 180. In one or more implementations, the merchant server may also cryptographically sign the order information (e.g., using a private key of the merchant server and/or a certificate received from the mobile transaction system server(s)) before providing the order information to the client device

In one or more implementations, the merchant server may also receive a request from the client device to register for updates to the order. For example, the request to register for updates may include a push token from the client device (e.g., and/or the merchant identifier, the order identifier, and/or the authentication information). The merchant server may obtain an update to the order, provide (e.g., 522) a push notification to the client device indicating the update to the order, receive a request for the update (e.g., from the client device) responsive to the push notification, and provide the update to the client device responsive to the request for the update. In one or more implementations, an update to order information may include a status update to a new status for the order, such as an order received status, an order processing status, an order shipped status, an order out-for-delivery status, an order delivered status, or an issue/problem status. In one or more implementations, the order information may also include an image, an order number, an amount paid, an issue/problem report or notification, shipping information, such as a shipping address or a shipping status, and/or pickup information (e.g., a pickup time, a pickup address, a bar code or QR code, etc.).

FIG. 11 conceptually illustrates an electronic system 1100 with which one or more implementations of the subject technology may be implemented. The electronic system 1100 can be, and/or can be a part of, one or more of the electronic devices 102A-C, and/or one or more of the servers 120, 140, 150, and/or 180 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a disk drive, a flash drive, and the like) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, one aspect of the present technology is the gathering and use of data available from various sources to improve the user configurable direct transfer system. The present disclosure contemplates that in some instances, this gathered data may include personal information data that uniquely identifies or can be used to contact or locate a specific person. Such personal information data can include demographic data, transaction data, order information, location-based data, telephone numbers, email addresses, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide order information to a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing order information, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, order information can be configured based on non-personal information data or a bare minimum amount of personal information, such as content being requested by the device associated with a user, other non-personal information available, or publicly available information.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
performing, by an electronic device, an electronic transaction for an order, in part by providing payment information stored at the electronic device to a point of service;
receiving, at the electronic device from the point of service, a transaction confirmation indicating completion of the electronic transaction;
receiving, at the electronic device responsive to the completion of the electronic transaction, order identification information for the order, the order identification information including a network identifier; and
obtaining, by the electronic device, from a system associated with the network identifier and the point of service, order information for the order.

2. The method of claim 1, wherein the point of service comprises a merchant server associated with a merchant corresponding to the order.

3. The method of claim 1, wherein the point of service comprises a near field communications terminal associated with a merchant corresponding to the order.

4. The method of claim 1, further comprising storing the order information at the electronic device for display in a user interface of a wallet application at the electronic device.

5. The method of claim 1, wherein the order identification information includes a merchant identifier associated with a merchant corresponding to the order, an order identifier for the order, the network identifier, and authentication information.

6. The method of claim 5, wherein obtaining the order information for the order comprises:
providing, by the electronic device, the merchant identifier, the order identifier, and the authentication information to the system at a network address corresponding to the network identifier; and
receiving the order information from the system at the electronic device responsive to providing the merchant identifier, the order identifier, and the authentication information.

7. The method of claim 1, wherein receiving the order information comprises receiving the order information in an encrypted bundle with a cryptographic signature from the system associated with the network identifier, the method further comprising:
verifying the encrypted bundle using the cryptographic signature; and
decrypting the encrypted bundle using a public key of the system obtained from another system.

8. The method of claim 1, wherein the order information includes one or more of an image associated with the order, a logo of a merchant associated with the system, a status of the order, a name of the merchant associated with the order, an order number, a name of a product or service associated with the order, shipping information for the order, an amount associated with the order, an additional link for modifying the order, pickup information, and an encoded identifier of the order.

9. The method of claim 1, further comprising:
receiving, by the electronic device from a user of the electronic device after receiving the order information, a user input including a request to send the order information to another electronic device associated with another user; and
sending, by the electronic device responsive to the request, the order information to the other electronic device.

10. The method of claim 1, wherein the electronic device and at least one other electronic device are associated with a user account, the method further comprising:
synchronizing the order information across the electronic device and the at least one other electronic device by providing the order information to shared storage associated with the user account at a cloud storage server for distribution from the cloud storage server to the at least one other electronic device.

11. A device comprising:
a memory; and
one or more processors configured to:
receive, responsive to a completion of a transaction for an order, order identification information for the order, the order identification information including a network identifier;
obtain from a system associated with the network identifier, order information for the order; and
store the order information for display in a user interface of a wallet application at the device.

12. The device of claim 11, wherein the one or more processors are further configured to:
perform an electronic transaction for the order, in part by providing payment information to a point of service; and
receive, from the point of service, a transaction confirmation indicating completion of the electronic transaction.

13. The device of claim 12, wherein the point of service comprises a near field communications terminal associated with a merchant corresponding to the order or a merchant server associated with a merchant corresponding to the order.

14. The device of claim 11, wherein the order identification information includes a merchant identifier associated with a merchant corresponding to the order, an order identifier for the order, the network identifier, and authentication information.

15. The device of claim 14, wherein the one or more processors are configured to obtain the order information for the order by:
providing the merchant identifier, the order identifier, and the authentication information to the system at a network address corresponding to the network identifier; and
receiving the order information from the system responsive to providing the merchant identifier, the order identifier, and the authentication information.

16. A system comprising:
a merchant server configured to:
provide a registration request to a mobile transaction system server;
receive, responsive to the registration request, a merchant identifier;
receive, after receiving the merchant identifier, an indication of a completed transaction for an order;
provide an order identifier, the merchant identifier, and authentication information for the order for distribution to a client device;
receive, after providing the order identifier, the merchant identifier, and the authentication information for distribution to the client device, a request from the client device for order information for the order, the request including at least the order identifier and the authentication information; and
provide, to the client device and responsive to the request for the order information, the order information for the order.

17. The system of claim 16, wherein the merchant server is configured to authenticate the request using the authentication information received in the request prior to providing the order information to the client device.

18. The system of claim 17, wherein the merchant server is further configured to encrypt the order information before providing the order information to the client device.

19. The system of claim 17, wherein the merchant server is further configured to cryptographically sign the order information before providing the order information to the client device.

20. The system of claim 17, wherein the merchant server is further configured to:
receive a request from the client device to register for updates to the order;
obtain an update to the order;
provide a push notification to the client device indicating the update to the order;
receive a request for the update responsive to the push notification; and
provide the update to the client device responsive to the request for the update.
